(19) United States
(12) Patent Application Publication
(10) Pub. No.: US 2001/0056387 A1
(43) Pub. Date: Dec. 27, 2001

(54) Method and apparatus for providing financial transaction data via the internet

(75) Inventors: Alex Magary, Brookline, MA (US); Lenny Driscoll, Andover, MA (US); Robert Legasey, Princeton, MA (US); Garrett Wiley, San Francisco, CA (US)

Correspondence Address: WOLF GREENFIELD & SACKS, PC, FEDERAL RESERVE PLAZA, 600 ATLANTIC AVENUE, BOSTON, MA, 02210-2211, US

(73) Assignee: NewRiver, Inc.

(21) Appl. No.: 09/785,630

(22) Filed: Feb. 16, 2001

Related U.S. Application Data
(60) Provisional application No. 60/183,285, filed on Feb. 17, 2000.

(51) Int. Cl. G06F 17/60

(52) U.S. Cl. 705/30; 705/35; 705/39

(57) ABSTRACT

In an on-line financial data system, financial transaction data is provided to a user electronically via a connection such as the Internet. The system stores representations of the financial data for retrieval by an account holder. In order to retrieve or receive the financial information via the Internet, a user must first consent to receiving the financial data in this manner. Consents are stored in the financial data system. When financial data is received by the system, a comparison is made with the pre-stored consents to determine if the data can be provided via the Internet. If so, then a corresponding paper-based version of the data is suppressed, that is, not sent to the account holder. Instead, a message having a pointer, e.g., a URL address, is provided to the account holder in order to allow the account holder access, via the world wide web on the Internet, to the financial data stored in the on-line financial data system.

### RELATED APPLICATION

Pursuant to 35 U.S.C. 119 this application claims the priority of provisional application Ser. No. 60/183,285, filed on Feb. 17, 2000.

### FIELD OF THE INVENTION

The present invention is related to providing financial transaction data electronically.

### BACKGROUND

More and more people every day are conducting their personal financial business, such as banking and investing, on-line. Today, with access to the Internet so prevalent, many are actively managing their own stock portfolios on a day-to-day basis. The efficiencies gained by using the services of on-line brokerages such as E*Trade, Datek, Ameritrade, just to name a few, have made the associated per-trade costs sufficiently low to make such transactions economically feasible for an individual.

Typically, a user accesses his account through a secured connection to a broker's website. Security is usually provided over a Secure Socket Layer (SSL) connection as well as with username/password verification and encryption. Since financial transactions are involved, there is heightened sensitivity to assuring that transactions are secure from fraudulent users.

While the Internet has allowed increased access to the trading of stocks, effectively lowering the barrier of entry for an individual, on-line brokerages must still comply with reporting rules from the Securities and Exchange Commission (SEC). Specifically, at least with respect to mutual fund purchases, prior to purchase of shares in a mutual fund, a user must be provided with a prospectus of the fund. In addition, after purchasing shares in a mutual fund, subsequent reports also must be sent to the investor.

Additionally, for every transaction that an investor makes with an on-line brokerage, a record or confirmation of the transaction shortly thereafter must be sent to the investor. Typically, at the end of each business day, data representing all transactions conducted at a brokerage are downloaded to a processing facility for generation of a paper record of the transaction to be mailed to the investor. These mailings can include account balances, records of purchases indicating number of shares and price for each, and redemptions of shares, including number of shares and price. In addition, year end tax statements also must be mailed to each investor. In some instances, where checks can be written against funds held by the brokerage, typically, at the end of a month, copies of all checks received against an account also are sent to the investor with a monthly listing of transactions.

The increased use of on-line brokerage services and other financial services has out paced the paper-based mechanisms. The generation of paper reports for on-line financial transactions represents a hindrance to fully leveraging the benefits of on-line trading and financial transactions through the Internet.

### SUMMARY

Described below is a system that provides for delivering financial transaction data electronically to a user of financial services. One embodiment is a system for warehousing financial transaction data for a plurality of financial transactions comprising a means for receiving financial transaction data, a means for determining a unique identifier for each element of the financial transaction data, and a means for storing each element of the financial transaction data with its respective unique identifier.

The system may operate over the Internet, and may provide financial transaction information in a variety of formats. The system may make financial transaction data available to a user electronically: this electronic transmission may take the place of a paper based representation of the financial transaction data.

The system may operate according to a client/server model.

### BRIEF DESCRIPTION OF THE DRAWINGS

A better understanding of the invention will follow with reference to the following drawings:

FIG. 1 is a diagram showing the operation of a document warehouse system;

FIG. 2 is a flowchart showing the document warehouse work flow for trade confirmations;

FIG. 3 is a diagram showing the operation of a consent management system;

FIG. 4 is a flowchart showing the consent confirmation flow; and

FIG. 5 is a diagram showing the operation of a system of paper suppression.

### DETAILED DESCRIPTION

In order to remedy the inefficiencies involved with paper-based record keeping and reporting for electronic on-line financial transactions, a system is provided to store the information that must be provided to a user of a financial system in an electronic format. Furthermore, the system is capable of suppressing paper-based transmission of the financial information and replacing it with either transmission of an electronic copy of the data or transmission of a pointer or link, e.g., a URL (Uniform Resource Locator) address, or hyperlink, directing the user to the information. A URL is the global address of documents and other resources located on a website on the world wide web. A first part of the address indicates what protocol to use and a second part specifies the Internet Protocol (IP) address or the domain name where the resource is located.

In order to replace the paper-based transmission of the financial information to a user with electronic transmission, the SEC has developed a set of compliance regulations specifically for electronic delivery of financial information and requires that a user consent to having such information either delivered electronically or maintained electronically where a user can access it, e.g., through the Internet. A system is provided which may allow a user to consent to electronically receive either all information or only particular information. For instance, a user may elect to receive daily trade confirmations electronically, but still opt to receive a monthly report in a paper-based format for record keeping purposes. Thus, the system provides a mechanism for identifying which particular transactions, potentially by type or fund, are to be electronically transmitted. By default, any information that is not specifically consented to by a user will be transmitted by the paper-based mechanism.

In the description to follow, an example of a brokerage house operating the various embodiments of the present invention is provided. This is only an example and it is not intended to limit any aspect of the present invention to just brokerage houses. It is intended that the present invention is applicable to other types of financial institutions in addition to operations that are not necessarily financial in nature but which have similar reporting requirements.

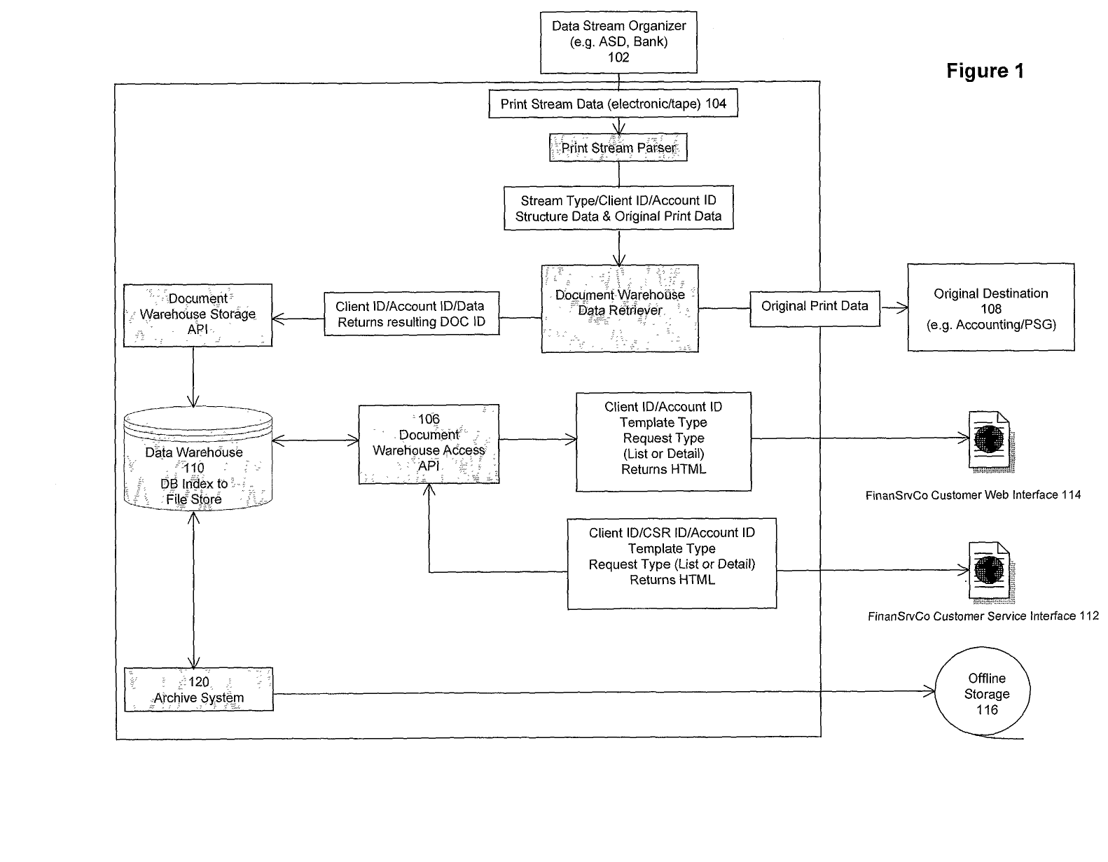

As shown in FIG. 1, financial transaction data, e.g., a stock trade confirmation or cleared check images, is received from a data stream originator 102 as print stream data 104 in either electronic or tape format. The print stream data then is parsed to identify stream type, client ID, and account ID. The print stream data then is converted into formatted data and added to a document warehouse database 110 indexed by the client ID and account ID. The warehousing system 100 passes the original print data, unmodified, to a paper-based processing center 108.

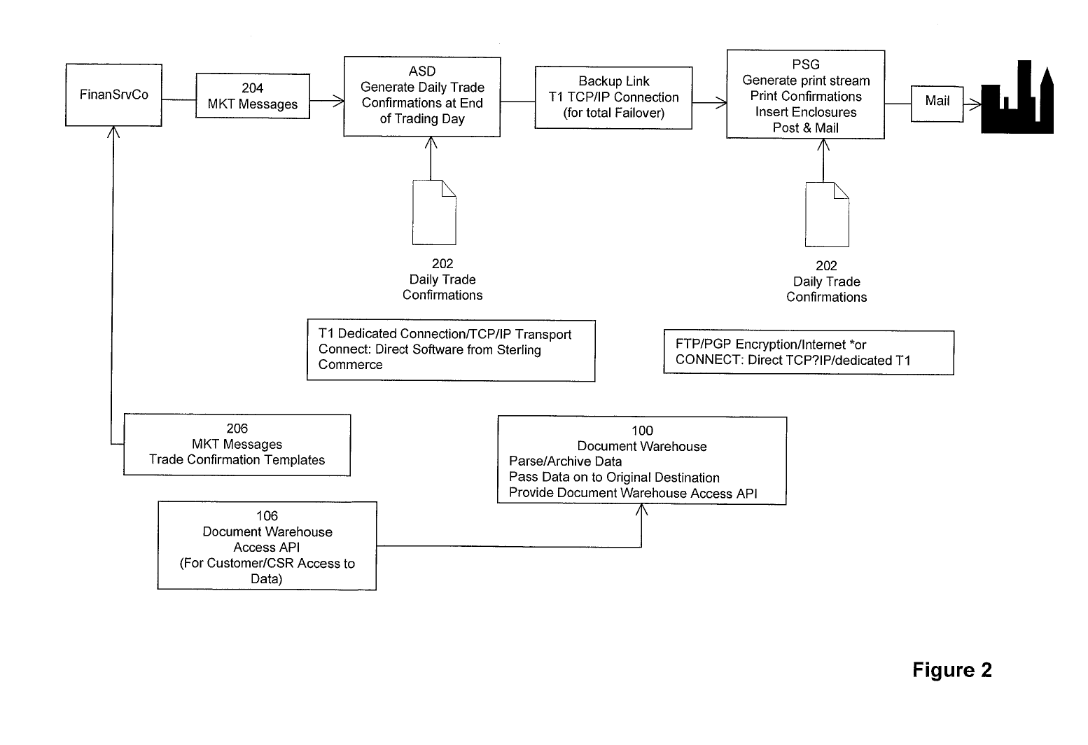

A document warehouse access API (Application Programming Interface) 106 allows access, via the Internet, to the data in the data warehouse. Two types of accesses are envisioned. A first type of access is performed by the customer service function of the brokerage as shown by the FinanSrvCo customer service interface 112. A second type of access is performed by a customer of the brokerage house, e.g., FinanSrvCo customer web interface 114. The document warehouse access API 106 may exist externally to the warehouse system 100 (as shown in FIG. 2).

In each example of access via the Internet, the document is identified by the combination of at least the client ID and the account ID. In addition, with respect to the customer service access, a customer service representative ID also would be necessary. In the latter form of access, it is envisioned that there may be instances where customer service, either in response to a query from the investor, or for normal maintenance purposes, must access an individual investor's account information.

In one embodiment, the brokerage customer would access the data in the data warehouse database via an icon or link provided by the brokerage on its web site. This would provide a first level of security and validation in that the brokerage front end would validate the user. Then, when access is requested, the document warehouse access API 106 may determine that the access request is arriving from or through a known location, i.e., the known brokerage, and thus have a higher level of confidence that it is a valid request.

The information in the print stream data 104 can relate to, for example, monthly financial statements, daily trade confirmations or daily check images. A flowchart integrating the document warehouse with a paper-based trade confirmation data flow is shown in FIG. 2. As shown in FIG. 2, the document warehouse 100 receives daily trade confirmation data 202 that is generated at the end of a trading day from data received from a brokerage facility. Additionally, the document warehouse 100 receives marketing messages 204 from the brokerage house. These marketing messages are meant to be included on the daily trade confirmations that are sent to the investor. If the brokerage house desires that the information be provided to a user in a particular format, templates 206 describing this format also are provided to the document warehouse.

The document warehouse functions to parse the daily trade confirmation data as described above. Specifically, the functions include: determining the account ID and the client ID so that a unique identifier can be provided with the data for later retrieval.

In order to provide appropriate data integrity, the documents in the data warehouse database 110 may be archived on a periodic basis and placed in off line storage 116.

The SEC requires that information with respect to electronic delivery be archived. The present invention operates to automatically meet these compliance requirements under the SEC's archiving regulations in conjunction with the on-line operation of the document warehouse database. The archiving system 120 is integrated so that the information, documents, data and e-mails to be archived (the “Documents”) are automatically stored on optical media upon electronic delivery and can be viewed from the archive online. At the time of storage the archive system 120 automatically verifies the quality and accuracy of the storage process. Some Documents are generated using templates. The archive system 120 does not store every Document individually, but rather stores one copy of each template along with the data necessary to recreate the Document. Thus, the archive system significantly reduces the amount of storage space necessary, while still preventing modification of the Documents (the securities laws require that the Documents be stored on “non-erasable non-rewriteable format media”). The archive system 120 also automatically serializes and times tamps each Document upon delivery and creates an index to allow the Documents to be located on the optical media. Each Document and index is automatically copied and stored on multiple optical disks. The archive system 120 also allows the option to automatically delete or relocate storage of the Documents (to a hard drive or other media) upon expiration of the applicable regulatory time period. The archive system 120 will readily download the Documents and indexes to various forms of media.

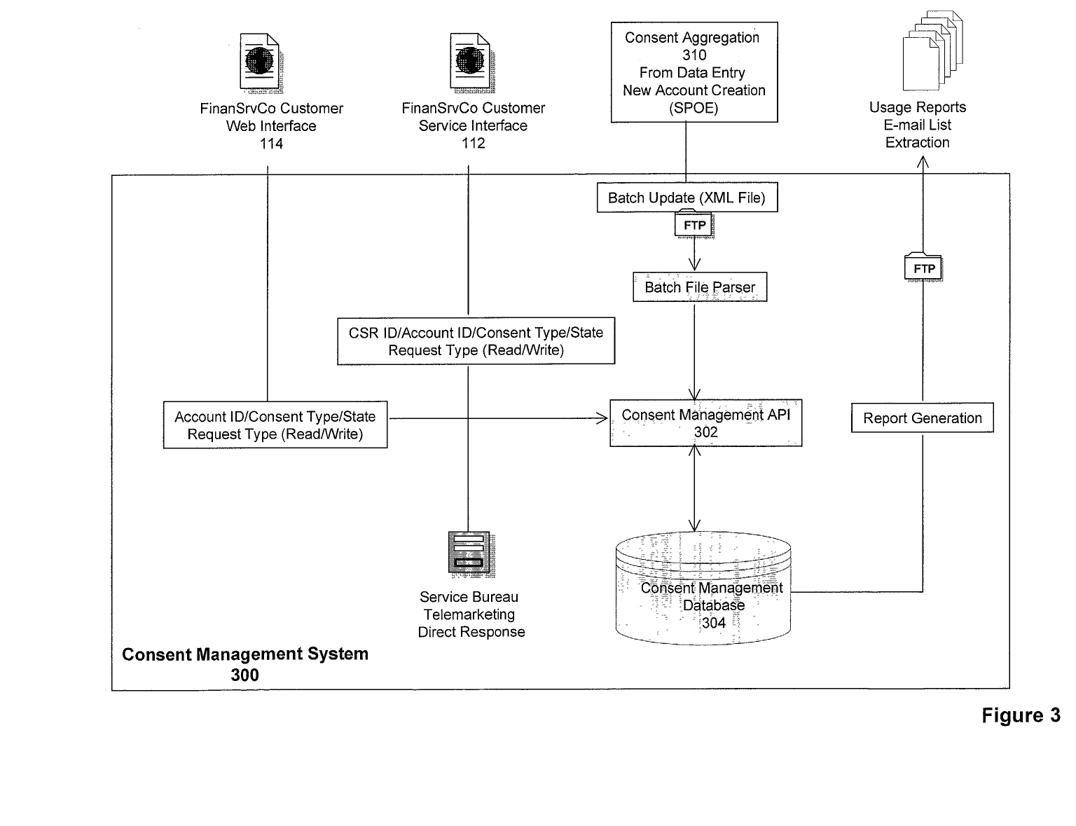

In order for an individual investor to receive SEC-compliant information electronically in place of paper-based receipt, the individual first must consent to such delivery. This consent must be clearly obtained by the brokerage and the individual must be fully informed prior to consenting in order to comply with SEC rules. In one embodiment, as shown in FIG. 3, the broker provides a page on its web site for the individual investor to request and confirm that electronic delivery of financial statements has been requested. The identity of the investor has to be confirmed through the use of account numbers and passwords. Typically this is how the investor interfaces with the web site any time a transaction is desired.

A user may consent to electronic delivery of either all types of financial information documents for all relevant accounts or may decide to receive only certain types of documents for specific accounts electronically while maintaining the paper-based transmission for other accounts and/or types of documents. Accordingly, the web interface presented to the user may allow the user to make such a selection.

As shown in FIG. 3, once the individual has defined the specific items which will be electronically delivered, this information is provided to a consent management API 302. The information received by the consent management API 302 includes at least an account ID, a consent type and a state request type. A consent management database 304 then is maintained using a listing of the accounts and users who have submitted consent for electronic delivery of financial information retrievable by at least one of account ID, customer ID and document ID.

In addition, the consent management system 300, through the consent management API interface 302 to the consent management database 304, allows a customer service representative from the brokerage to access the information with respect to consents in the consent management database by using the customer service interface 306. Of course, such access must be verified through either the use of passwords or other types of secured connections. Typically, a customer service representative would have a customer service representative identifier that would allow only access to accounts relative to the particular brokerage or financial service firm. This is particularly important since a single user may have consents stored in the consent management database for accounts held by different brokerages or financial institutions. Thus, a customer service representative for one financial institution would not be able to access a customer's consent records for a brokerage or financial institution other than the one for which the customer service representative works.

In the foregoing embodiment, a user accesses the consent management system through a web interface 114 hosted by a brokerage or financial institution. This is convenient to the individual since the brokerage or financial institution will already know which accounts the individual maintains at that institution and will be able to assist the individual in identifying accounts and reports that might be retrievable in electronic format.

Alternatively, a service may be provided to individuals to directly register with a consent clearinghouse so that the individual may register consent to receiving financial data electronically for either all accounts that the individual may own or just specific ones, as shown by Consent Aggregation 310 in FIG. 3. An individual would identify to the consent management clearinghouse the account numbers and the institutions where the accounts are held and the clearinghouse would then notify these institutions that financial statements are to be sent electronically and not as paper-based materials.

Finally, an individual's consent to receiving electronic versions of financial data may be recorded by submitting a paper-based form, or through a telephone conversation with a customer service operator, or via an automated attendant by using the keypad of a touch-tone phone. This information would then be transferred into the consent management database for storage.

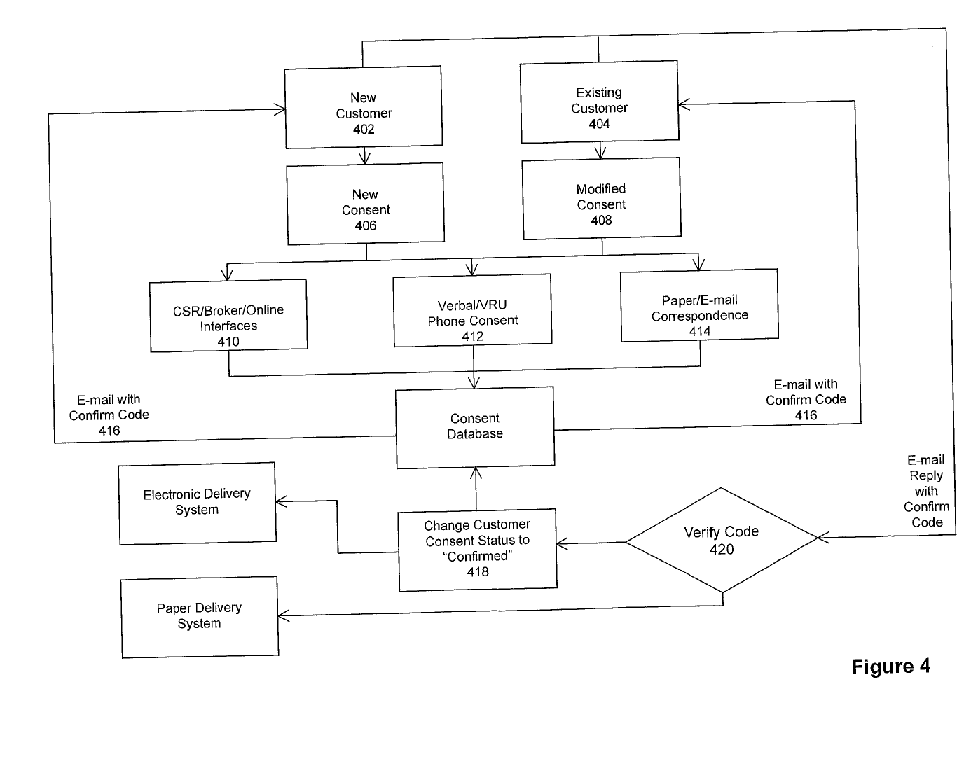

Irrespective of the mechanism above that is used for submitting consent, the consent management system 300 will confirm the individual's consent. As shown in FIG. 4, a customer, either new 402 or existing 404, will submit new consent 406 or modified consent 408 via any one or more method. As shown, this may be Customer Service Representative (CSR)/Broker/Online interfaces 410, verbally over the phone, via keypad entry 412 or paper/e-mail correspondence 414. Once consent is received, an e-mail message with a confirm code 416 is sent to the individual at the identified e-mail address along with a request for a reply. When the reply e-mail is received, if the code is verified 420, the customer's status is changed to “confirmed” 418. The e-mailed reply would then be held by the financial institution as evidence of the confirmation in the event that there is some question regarding the granting of consent. If the code is not verified, then the consent is not confirmed and operation reverts to the default paper delivery system 422.

An individual may withdraw consent to electronic receipt of financial data through any of the same methods herein provided for providing consent. In addition, the individual may withdraw either all consents or only some consents, similar to the granting of consents described.

While the preferred embodiment describes the paper-based delivery of financial information as the default, the present invention may easily be applied in the situation where electronic delivery is the default. In this situation, an individual would then “opt-out” of this mode of delivery through the “consent” mechanism described herein. Of course, the individual may choose to opt-out for all transmissions or only specific ones. In some instances, as per SEC rules, the default mode is already electronic delivery but the individual is given sixty days to “opt-out” before the electronic delivery starts.

When two or more individuals live at the same postal address, they may consent to having one statement mailed to them. This is called “household” consent. This one statement would then reference all accounts either held together or individually and helps to reduce the number of unnecessary mailings. Similarly, where two or more individuals have the same e-mail address, they may consent to having their respective individual reports or data sent electronically via e-mail. They may also consent to having the information placed in a single e-mail.

Further, similar to the mailed version, where the default is household consent in that all mailings to the same postal address will be combined into one, the default condition may be to place all transmissions going to the same e-mail address, irrespective of the number of individuals or accounts, into one transmission. Each individual may then opt out of the household and then, if electronic transmission was not desired, the individual would have to opt out of that, as well. This may all be accomplished via the same mechanism as the consent mechanism described above in reference to FIG. 4.

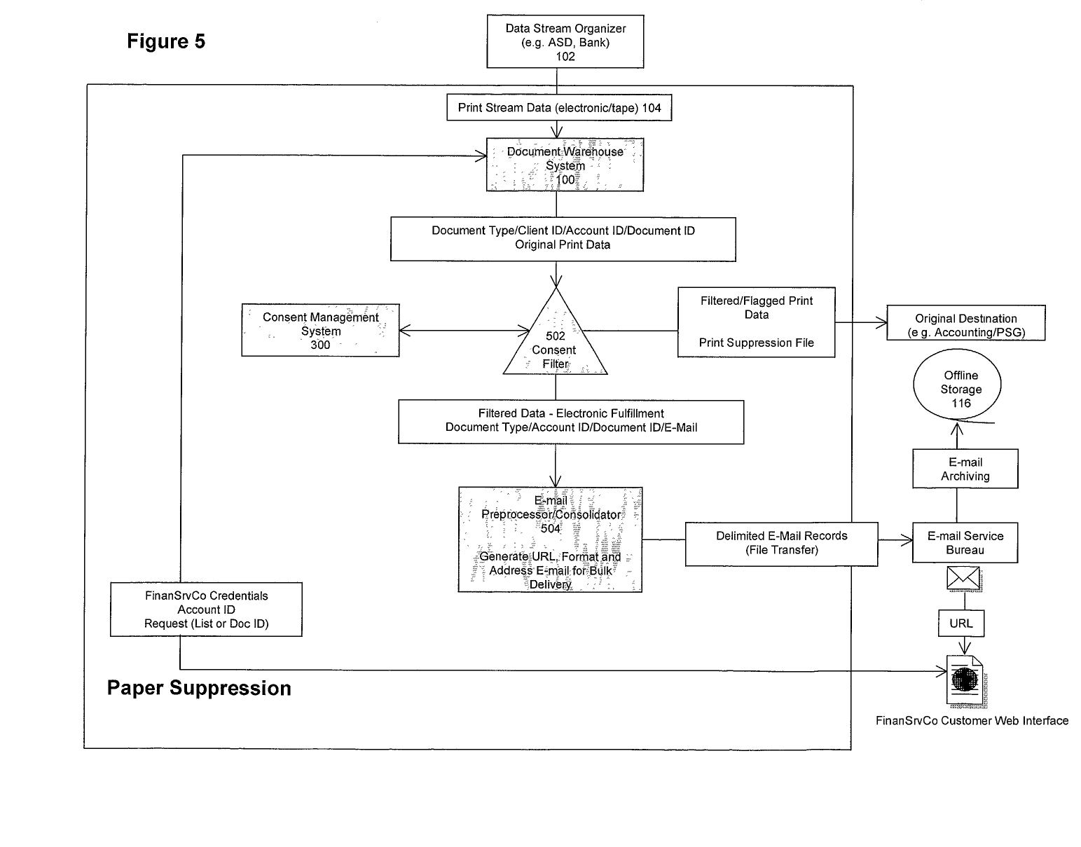

The system further allows an individual to retrieve electronic versions of financial information, while at the same time preventing redundant or duplicate paper-based versions of this same information being sent through the mail system. As shown in FIG. 5, a data stream originator 102 provides financial data, e.g., monthly statements, transaction confirmations, check images, etc., all as discussed above. The document warehouse system 100 receives this print stream data and, as has been described above with respect to FIG. 1, processes the information and stores it in the data warehouse database indexed by at least one of customer ID, account ID, document ID, etc.

A consent filter 502 receives the document identifier information derived from the document warehouse system 100. In addition, the consent filter 502 has access to the consent management system 300 which contains a record of stored consents to receive electronic versions of financial data. The filter 502 compares the consents that are stored in the consent management system 300 with the data identifiers and identifies the information that may be made available electronically. It should be remembered that the default condition may be that the paper-based version will be sent absent any explicit instructions to the contrary.

Thus, when the system that is provided to send the paper-based version receives the print stream data, it may compare the print suppression list (which includes the list of documents not to be mailed) against its mailing list.

The consent filter 502 identifies the data that is to be electronically provided by indicating the document type, account ID, document ID and the e-mail address to which it is to be sent.

An e-mail pre-processor/consolidator 504 receives the information from the consent filter 502. The pre-processor/consolidator 504 then formats an e-mail message for each email addressee that will be receiving on-line financial data. The e-mail message will include a URL link generated by the pre-processor/consolidator 504 pointing to the particular data record in the document warehouse system. The pre-processor/consolidator 504 also identifies when multiple e-mails have been prepared for sending to the same individual account and email address pair. This is important since two individuals, with respective, separate, accounts, may be using the same e-mail address. When this occurs, only a single e-mail message may be sent, however, it may contain multiple URLs directing the recipient to different transaction data.

In the event that the e-mail delivery is unsuccessful, alternate arrangements may be made, for example, a paper version may be mailed. In one embodiment, the system may attempt to successfully e-mail the information three times. If delivery is unsuccessful the third time, a paper version will be mailed to the individual with a notice that e-mail delivery was attempted but was unsuccessful. If this occurs on three successive, distinct, transmissions, e.g., Monday's, Tuesday's and Thursday's messages for a total of nine attempts, then the system may “revoke” the consent, revert to paper confirmations or reporting and notify the individual of the inability to successfully send e-mail to the e-mail address that has been provided. The individual may then have to correct the situation and resubmit consent to electronic delivery.

Once all of the e-mail messages are generated and formatted, they may be provided as delimited e-mail records, either through a file transfer or some other mechanism, to a commercial e-mail service bureau for transmission to the recipients. The e-mail service bureau then sends the bulk mailing to the individual investors.

After mailing, the individual may receive an e-mail message having one or more URLs or hyperlinks attached thereto. The hyperlink may have an informational label, e.g., “December 1999 Monthly Statement” to clearly explain what has been sent to the recipient. By “clicking” on the URL, the user is directed to the data. In one embodiment, the user will be directed to the web interface for the particular brokerage or financial institution from which the financial data is relevant. The brokerage or financial institution web interface may then validate the user through the standard validation process, e.g., identifier and password.

The financial institution web interface, once it has satisfactorily confirmed identification of the user, will then direct the user to the particular document stored on the document warehouse system. This document warehouse system may be a system or server other than the financial institution's server. In other words, an advantage of the present system is that the financial transaction data is centrally stored although, to a user, it would appear that the information is coming from the financial institution's web site. The user may then review the information, store it to a local disk or print it out on a local printer.

While the functional specification describes an embodiment related to the on-line receipt of trade confirmations, monthly or periodic statements and check images, it is envisioned that the inventions described herein are equally applicable to many other systems where paper-based reports are provided. These applications include, but are not limited to, banking institutions with monthly statements being made available electronically rather than on paper, pay stubs provided to an employee who has opted for direct deposit and thus does not receive a real check, credit card bills, utility bills, mortgage bills, etc. Almost any instance where a paper-based document is sent in the mail represents an opportunity where the present invention may be employed

Greater efficiencies will be gained through such a suppression of the paper-based material, in that cost will be reduced and these cost savings can then be passed along to the consumer. In addition, as a benefit for the environment, less paper will be used thus saving many millions of trees from destruction every year.

In the embodiments discussed above and discussed below in more detail, the e-mail message includes a link directing the e-mail recipient to information stored on a remote server. Depending upon the application, however, rather than a URL link, an electronic file may be attached to the e-mail message. This file, when opened by the recipient, would then contain the financial information. Of course, for security reasons, the information may have to be encrypted where security codes or passwords are pre-arranged between the sender and the recipient. Still further, the data stored in the data warehouse, whether a recipient is directed to it by a link or receives it as an attached file, may be in a format such that it could be incorporated directly into any one of a number of commercially available financial software programs such as Intuit's Quicken or Microsoft's Money. This would be helpful to an individual who maintains records of finances on one of these software programs in that debits, or credits, or checks applied, or gains, or losses in accounts can be automatically entered into the programs without the necessity of the user having to re-type the information. This direct importation reduces the chances of errors occurring when the data is re-entered.

Still further, in addition to, or rather than a link to the financial transaction data being placed in the e-mail or the information attached to it, the e-mail may inform the user that financial transaction data is available on the financial institution's web site for review or retrieval. The user may then access the financial institution's web site and be directed to a section of the web site where the user's information is available. Here the same link or links that are described above as being sent with the e-mail would be presented to the user for access. In this way, the information may be grouped by account and given an explanatory label and not a cryptic URL link string. For example, a link may be labeled “January 2000 Monthly Statement” and when accessed by the user, the information may be retrieved from the data warehouse. One advantage of this method is the ability of the financial institution to provide one location where the user can access data and which can be used as an on-line archive. The user need only access the web site and proceed to the user's information. As a result, the user does not have to maintain separate bookmarks for each e-mail and the institution can offer this as a value added service to the users. Still further, the financial institution lowers the chance for fraudulent access to a user's information since the URL links are never transmitted and the security arrangements for access to the web site are in place for the user to access the data.

In order for the financial institution's web site to be able to offer this “archive” of information to the user, the system may notify the institution when financial information is available for a user who has consented to electronic receipt. This, however, is straightforward since the institution may be notified with the same information that is sent to the e-mail service bureau as discussed with reference to FIG. 5. From this information, the user may be identified as well as the type of data that is available.

In addition to sending an e-mail message to a user, it is possible that a reminder may be provided to the user when the user next accesses the web site. Specifically, the financial institution may add a feature to let the user know that information is available electronically and tell the user that an e-mail was sent to him/her at a particular address. The user may then access the e-mail account or realize that the e-mail account information is out-dated and then correct it.

Still further, the financial institution may let all of its users know that their information is available on-line even if a particular user has not consented to receiving the data electronically. It may be an adjunct to the paper-based transmission and would allow a user to review past data (depending upon how much is maintained on-line) without having to dig through the paper files. This feature may allow the user to become more comfortable with accessing the information on-line after which they might consent to receiving the data electronically.

While there have been shown and described what are at present considered the preferred embodiments of the present invention, it will be obvious to those skilled in the art that various changes and modifications may be made therein without departing from the scope of the invention as defined by the appended claims.

What is claimed is:

1. A system for warehousing financial transaction data for a plurality of financial transactions, the system comprising:
means for receiving the financial transaction data for the plurality of financial transactions;
means for determining a unique identifier for each element of financial transaction data; and
means for storing each element of financial transaction data with its respective unique identifier.

2. The system of claim 1, wherein the receiving means comprises:
means for receiving the financial transaction data over the Internet.

3. The system of claim 1, wherein the financial transaction data comprises at least one of:
a trade confirmation;
tax related data;
an image of a cancelled check; and
account statement data.

4. The system of claim 1, further comprising:
means for accessing an element of financial transaction data in the storing means over the Internet according to its respective unique identifier.

5. The system of claim 4, wherein the accessing means comprises:
means for providing the financial transaction data in HTML format.

6. The system of claim 4, wherein the accessing means comprises:
means for receiving validation information to generate a respective unique identifier.

7. The system of claim 6, wherein the validation information is received over a secure connection.

8. The system of claim 6 or 7, wherein the validation information comprises at least one of:
a client identifier;
an account identifier;
a customer service representative identifier;
a template type identifier; and
a request type identifier.

9. A method of warehousing financial transaction data for a plurality of financial transactions, the method comprising:
receiving the financial transaction data for the plurality of financial transactions;
determining a unique identifier for each financial transaction; and
storing each financial transaction with its respective unique identifier.

10. The method of claim 9, wherein the receiving step comprises:
receiving the financial transaction data over the Internet.

11. The method of claim 9, wherein the financial transaction data comprises at least one of:
a trade confirmation;
tax related data;
an image of a cancelled check; and
account statement data.

12. The method of claim 9, further comprising:
accessing a stored financial transaction over the Internet according to its respective unique identifier.

13. The method of claim 12, wherein accessing the financial data comprises:
providing the financial transaction data in HTML format.

14. The method of claim 12, wherein the accessing step comprises:
receiving validation information to generate a respective unique identifier.

15. The method of claim 14, wherein the validation information is received over a secure connection.

16. The method of claim 15, wherein the validation information comprises at least one of:
a client identifier;
an account identifier;
a customer service representative identifier;
a template type identifier; and
a request type identifier.

17. A method of making financial transaction information available electronically, the method comprising:
(a) receiving financial transaction data for a plurality of distinct financial transactions;
(b) determining a unique identifier for each distinct financial transaction and a client associated with each distinct financial transaction;
(c) determining, as a function of each unique identifier, whether the associated client has consented to receiving the respective financial data electronically; and
(d) if it is determined that the associated client has consented to receiving the respective financial data electronically, making the respective financial transaction data available to the associated client electronically.

18. The method of claim 17, wherein step (d) comprises making the respective financial transaction data available to the associated client via the Internet.

19. The method of claim 17, further comprising:
(e) suppressing transmission of a paper-based version of the consented respective financial data determined in step (d).

20. The method of claim 19, wherein the unique identifier comprises at least one of:
a client identifier;
an account identifier;
a document type identifier;
a customer service representative identifier;
a document identifier;
a consent type identifier; and
a request type identifier.

21. The method of claim 20, wherein step (c) comprises:
comparing each unique identifier associated with the received financial transaction data with pre-stored identifiers.

22. The method of claim 17, wherein step (d) comprises:
providing the associated client with a URL link to the respective financial transaction data.

23. The method of claim 22, wherein the respective financial transaction data is in an HTML format.

24. The method of claim 17, wherein step (d) comprises:
sending an e-mail message directly to an e-mail address of the associated client,
wherein the e-mail message comprises the retrieved respective financial transaction data.

25. The method of claim 24, wherein the e-mail message comprises an image file representative of the respective financial transaction data.

26. The method of claim 24, wherein the e-mail message comprises a data file for incorporation into a financial software program.

27. The method of claim 24, further comprising:
maintaining a record of each sent e-mail message that does not successfully reach its intended e-mail destination; and
sending a paper-based representation of the financial transaction data associated with each unsuccessfully sent e-mail message.

28. The method of claim 17, further comprising:
under control of a client system:
displaying information identifying at least one financial transaction type;
in response to an entry from a user, associating one of consent or non-consent to each at least one transaction type; and
sending a consent change request representing the entry from the user; and
under control of a server system:
receiving the consent change request;
confirming the consent change request is authorized; and
storing the associated one of consent or non-consent with the respective transaction type.

29. The method of claim 28, wherein the consent change request comprises an indication of an account and a password and the confirming step comprises:
comparing the password in the consent change request to a pre-stored password associated with the user.

30. The method of claim 28, wherein the client system and the server system communicate with one another over a secure connection via the Internet.

31. The method of claim 29, wherein the client system and the server system communicate with one another over a secure connection via the Internet.

32. The method of claim 17, wherein step (d) comprises:
under control of a client system:
sending a request to view the respective financial transaction data, the request comprising a client identifier; and
under control of a server system:
receiving the request from the client system,
retrieving, as a function of the client identifier, the respective financial transaction data; and
providing a link to the retrieved respective financial transaction data; and
under control of the client system, displaying the retrieved respective financial transaction data.

33. The method of claim 17, wherein step (d) comprises:
sending an e-mail message directly to an e-mail address of the associated client,
wherein the e-mail message comprises a URL link to the respective financial transaction data.

34. A system for making financial transaction information available electronically, the system comprising:
(a) means for receiving financial transaction data for a plurality of distinct financial transactions;
(b) first means for determining a unique identifier for each distinct financial transaction and a client associated with each distinct financial transaction;
(c) second means for determining, as a function of each unique identifier, whether the associated client has consented to receiving the respective financial data electronically; and
(d) means for making the respective financial transaction data available to the associated client electronically if it is determined that the associated client has consented to receiving the respective financial data.

35. The system of claim 34 further comprising means for making the respective financial transaction data available to the associated client electronically via the Internet

36. The system of claim 34, further comprising:
(e) means for suppressing transmission of a paper-based version of the consented respective financial data.

37. The system of claim 36, wherein the unique identifier comprises at least one of:
a client identifier;
an account identifier;
a document type identifier;
a customer service representative identifier;
a document identifier;
a consent type identifier; and
a request type identifier.

38. The system of claim 37, wherein the second determining means comprise:
means for comparing each unique identifier associated with the received financial transaction data with pre-stored identifiers.

39. The system of claim 35, wherein the means for making the respective financial transaction data available to the associated client via the Internet comprise:
means for providing the associated client with a URL link to the respective financial transaction data.

40. The system of claim 39, wherein the respective financial transaction data is in an HTML format.

41. The system of claim 35, wherein the means for making the respective financial transaction data available to the associated client via the Internet comprise:
means for sending an e-mail message directly to an e-mail address of the associated client,
wherein the e-mail message comprises the retrieved respective financial transaction data.

42. The system of claim 41, wherein the e-mail message comprises an image file representative of the respective financial transaction data.

43. The system of claim 41, wherein the e-mail message comprises a data file for incorporation into a financial software program.

44. The system of claim 41, further comprising:
means for maintaining a record of each sent e-mail message that does not successfully reach its intended e-mail destination; and
means for sending a paper-based representation of the financial transaction data associated with each unsuccessfully sent e-mail message.

45. The system of claim 34, further comprising:
a client system operative to:
display information identifying at least one financial transaction type;
in response to an entry from a user, associate one of consent or non-consent to each at least one transaction type; and
send a consent change request representing the entry from the user; and
a server system operative to:
receive the consent change request;
confirm the consent change request is authorized; and
store the associated one of consent or non-consent with the respective transaction type.

46. The system of claim 45, wherein the consent change request comprises an indication of an account and a password and the server system is further operative to:
compare the password in the consent change request to a pre-stored password associated with the user.

47. The system of claim 45, wherein the client system and the server system communicate with one another over a secure connection via the Internet.

48. The system of claim 46, wherein the client system and the server system communicate with one another over a secure connection via the Internet.

49. The system of claim 35, wherein the means for making the respective financial transaction data available to the associated client via the Internet comprise:
a client system to send a request to view the respective financial transaction data, the request comprising a client identifier; and
a server system operative to:
receive the request from the client system,
retrieve, as a function of the client identifier, the respective financial transaction data; and
provide a link to the retrieved respective financial transaction data; and
wherein, the client system displays the retrieved respective financial transaction data.

50. The system of claim 35, wherein the means for making the respective financial transaction data available to the associated client via the Internet comprise:
means for sending an e-mail message directly to an e-mail address of the associated client,
wherein the e-mail message comprises a URL link to the respective financial transaction data.

51. A computer program product comprising:
a computer-readable medium;
computer program instructions, wherein the computer program instructions, when executed by a computer, direct the computer to perform a method of warehousing financial transaction data for a plurality of financial transactions, the method comprising:
receiving the financial transaction data for the plurality of financial transactions;
determining a unique identifier for each financial transaction; and
storing each financial transaction with its respective unique identifier.

52. The computer program product of claim 51, wherein the receiving step comprises:
receiving the financial transaction data over the Internet.

53. The computer program product of claim 51, wherein the financial transaction data comprises at least one of:
a trade confirmation;
tax related data;
an image of a cancelled check; and
account statement data.

54. The computer program product of claim 51, further comprising:
accessing a stored financial transaction over the Internet according to its respective unique identifier.

55. The computer program product of claim 54, wherein accessing the financial data comprises:
providing the financial transaction data in HTML format.

56. The computer program product of claim 54, wherein the accessing step comprises:
receiving validation information to generate a respective unique identifier.

57. The computer program product of claim 56, wherein the validation information is received over a secure connection.

58. The computer program product of claim 57, wherein the validation information comprises at least one of:
a client identifier;
an account identifier;
a customer service representative identifier;
a template type identifier; and
a request type identifier.

59. A computer program product comprising:
a computer-readable medium;
computer program instructions, wherein the computer program instructions, when executed by a computer, direct the computer to perform a method of making financial transaction information available via a communications channel, the method comprising:
(a) receiving financial transaction data for a plurality of distinct financial transactions;
(b) determining a unique identifier for each distinct financial transaction and a client associated with each distinct financial transaction;
(c) determining, as a function of each unique identifier, whether the associated client has consented to receiving the respective financial data via the communications channel; and
(d) if it is determined that the associated client has consented to receiving the respective financial data, making the respective financial transaction data available to the associated client via the communications channel.

60. The computer program product of claim 59, further comprising:
(e) suppressing transmission of a paper-based version of the consented respective financial data determined in step (d).

61. The computer program product of claim 60, wherein the unique identifier comprises at least one of:
a client identifier;
an account identifier;
a document type identifier;
a customer service representative identifier;
a document identifier;
a consent type identifier; and
a request type identifier.

62. The computer program product of claim 61, wherein step (c) comprises:
comparing each unique identifier associated with the received financial transaction data with pre-stored identifiers.

63. The computer program product of claim 59, wherein step (d) comprises:
providing the associated client with a URL link to the respective financial transaction data.

64. The computer program product of claim 63, wherein the respective financial transaction data is in an HTML format.

65. The computer program product of claim 59, wherein step (d) comprises:
sending an e-mail message directly to an e-mail address of the associated client,
wherein the e-mail message comprise s the retrieved respective financial transaction data.

66. The computer program product of claim 65, wherein the e-mail message comprises an image file representative of the respective financial transaction data.

67. The computer program product of claim 65, wherein the e-mail message comprises a data file for incorporation into a financial software program.

68. The computer program product of claim 65, further comprising:
maintaining a record of each sent e-mail message that does not successfully reach its intended e-mail destination; and
sending a paper-based representation of the financial transaction data associated with each unsuccessfully sent e-mail message.

69. The computer program product of claim 59, further comprising:
under control of a client system:
displaying information identifying at least one financial transaction type;
in response to an entry from a user, associating one of consent or non-consent to each at least one transaction type; and
sending a consent change request representing the entry from the user; and
under control of a server system:
receiving the consent change request;
confirming the consent change request is authorized; and
storing the associated one of consent or non-consent with the respective transaction type.

70. The computer program product of claim 69, wherein the consent change request comprises an indication of an account and a password and the confirming step comprises:
comparing the password in the consent change request to a pre-stored password associated with the user.

71. The computer program product of claim 69, wherein the client system and the server system communicate with one another over a secure connection via the Internet.

72. The computer program product of claim 70, wherein the client system and the server system communicate with one another over a secure connection via the Internet.

73. The computer program product of claim 59, wherein step (d) comprises:
under control of a client system:
sending a request to view the respective financial transaction data, the request comprising a client identifier; and
under control of a server system:
receiving the request from the client system,
retrieving, as a function of the client identifier, the respective financial transaction data; and
providing a link to the retrieved respective financial transaction data; and
under control of the client system, displaying the retrieved respective financial transaction data.

74. The computer program product of claim 59, wherein step (d) comprises:
sending an e-mail message directly to an e-mail address of the associated client,
wherein the e-mail message comprises a URL link to the respective financial transaction data.

75. A system for warehousing financial transaction data for a plurality of financial transactions, the system comprising:
a financial transaction data processor to receive the financial transaction data for the plurality of financial transactions;
an identifier processor, coupled to the financial transaction data processor, to determine a unique identifier for each financial transaction received by the financial transaction data processor; and
a storage device, coupled to the financial transaction data processor and the identifier processor, to store each financial transaction with its respective unique identifier.

76. The system of claim 75, wherein the financial transaction data processor comprises:
an interface to receive the financial transaction data over the Internet.

77. The system of claim 75, wherein the financial transaction data comprises at least one of:
a trade confirmation;
tax related data;
an image of a cancelled check; and
account statement data.

78. The system of claim 75, further comprising:
access processor to process access to a financial transaction in the storage device over the Internet according to its respective unique identifier.

79. The system of claim 78, wherein the access processor provides the financial transaction data in HTML format.

80. The system of claim 78, wherein the financial transaction data processor receives validation information to generate a respective unique identifier.

81. The system of claim 80, wherein the validation information is received over a secure connection.

82. The system of claim 81, wherein the validation information comprises at least one of:
a client identifier;
an account identifier;
a customer service representative identifier;
a template type identifier; and
a request type identifier.

83. A system for making financial transaction information available via the Internet, the system comprising:
(a) a financial transaction data processor to receive financial transaction data for a plurality of distinct financial transactions;
(b) an identifier processor, coupled to the financial transaction data processor, to determine a unique identifier for each distinct financial transaction and a client associated with each distinct financial transaction;
(c) a consent processor, coupled to the identifier processor, to determine, as a function of each unique identifier, whether the associated client has consented to receiving the respective financial data electronically; and
(d) a processor, coupled to the consent processor, to make the respective financial transaction data available to the associated client electronically if it is determined that the associated client has consented to receiving the respective financial data.

84. The system of claim 83 further comprising an interface processor to make the respective financial transaction data available to the associated client electronically via the Internet

85. The system of claim 83, further comprising:
(e) a processor to suppress transmission of a paper-based version of the consented respective financial data.

86. The system of claim 85, wherein the unique identifier comprises at least one of:
a client identifier;
an account identifier;
a document type identifier;
a customer service representative identifier;
a document identifier;
a consent type identifier; and
a request type identifier.

87. The system of claim 83, wherein the consent processor compares each unique identifier associated with the received financial transaction data with pre-stored identifiers.

88. The system of claim 86, wherein the interface processor provides the associated client with a URL link to the respective financial transaction data.

89. The system of claim 88, wherein the respective financial transaction data is in an HTML format.

90. The system of claim 84, wherein the interface processor comprises:
an e-mail processor to send an e-mail message directly to an e-mail address of the associated client,
wherein the e-mail message comprises the retrieved respective financial transaction data.

91. The system of claim 90, wherein the e-mail message comprises an image file representative of the respective financial transaction data.

92. The system of claim 90, wherein the e-mail message comprises a data file for incorporation into a financial software program.

93. The system of claim 90, further comprising:
a record processor to maintain a record of each sent e-mail message that does not successfully reach its intended e-mail destination; and
a system to send a paper-based representation of the financial transaction data associated with each unsuccessfully sent e-mail message.

94. The system of claim 83, further comprising:
a client system operative to:
display information identifying at least one financial transaction type;
in response to an entry from a user, associate one of consent or non-consent to each at least one transaction type; and
send a consent change request representing the entry from the user; and
a server system operative to:
receive the consent change request;
confirm the consent change request is authorized; and
store the associated one of consent or non-consent with the respective transaction type.

95. The system of claim 94, wherein the consent change request comprises an indication of an account and a password and the server system is further operative to:
compare the password in the consent change request to a pre-stored password associated with the user.

96. The system of claim 94, wherein the client system and the server system communicate with one another over a secure connection via the Internet.

97. The system of claim 95, wherein the client system and the server system communicate with one another over a secure connection via the Internet.

98. The system of claim 84, wherein the interface processor comprises:
a client system to send a request to view the respective financial transaction data, the request comprising a client identifier; and
a server system operative to:
receive the request from the client system,
retrieve, as a function of the client identifier, the respective financial transaction data; and
provide a link to the retrieved respective financial transaction data; and
wherein, the client system displays the retrieved respective financial transaction data.

99. The system of claim 84, wherein the interface processor sends an e-mail message directly to an e-mail address of the associated client,
wherein the e-mail message comprises a URL link to the respective financial transaction data.

100. A method of providing financial transaction data electronically to a user, the method comprising:
obtaining consent from the user to provide the data electronically; and
providing the financial transaction data electronically to the user.

101. The method of claim 100, wherein the financial transaction data is provided to the user via the Internet.

102. The method of claim 101, wherein the financial transaction data is sent as part of an e-mail message.

103. The method of claim 102, wherein the e-mail message comprises a link directing the user to the provided financial transaction data.

104. The method of claim 100 wherein the user's consent is received via the Internet.

105. The method of claim 103, further comprising:
the user receiving the e-mail message;
the user accessing a web site on the Internet on which the link is located;
the user validating the user's identity by submitting identifying information to the web site;
a process running on a server system receiving the identifying information and confirming the identity of the user; and
the process on the server providing the user access to the information via the link.

106. The method of claim 105, further comprising:
the process on the server accessing, as a function of the link, a second server to provide the information to the user.

107. A method of obtaining and storing consent, from a user, to receive financial transaction data electronically, the method comprising:
under control of a client system:
sending a consent message with respect to the financial transaction data;
under control of a first server system:
receiving the consent message from the client system;
correlating the consent message to account information of the user and generating consented account information data;
sending the consented account information data;
under control of a second server system:
receiving the consented account information data from the first server;
determining a unique user identifier from the consented account information; and
storing the consented account information as a function of the unique user identifier.

108. The method as recited in claim 107, wherein the client system, the first server and the second server communicate with one another via the Internet.

109. A method of providing financial transaction data electronically, the method comprising:
under control of a first server system:
(A) receiving a request to retrieve financial transaction data from a client system;
(B) validating the request; and
(C) when the request is determined to be valid, providing the financial transaction data to the client system.

110. The method of claim 109, wherein step (B) comprises:
requesting an account number and password from the client system; and
comparing the account number and the password to a pre-stored database of information.

111. The method of claim 109, wherein the request comprises a URL link and wherein step (C) comprises:
under control of the first server system:
directing the client system to a location on a second server system as a function of the URL link.

112. The method of claim 109, wherein the request comprises a URL link and wherein step (C) comprises:
under control of the first server system:
directing the client system to a location on the first server system as a function of the URL link.

113. The method of any of claims 109-112, wherein the client system, the first server and the second server communicate with one another via the Internet.

114. A method of sending financial transaction data electronically to a user, the method comprising:
under control of a first server system:
(A) receiving financial transaction data;
(B) identifying a user associated with the received financial transaction data;
(B1) storing the received financial transaction data as a function of the identified user;
(C) determining if the identified user has consented to receiving the financial transaction data electronically;
(D) when it has been determined that the user has consented, sending the received financial transaction data electronically to the user.

115. The method of claim 114, wherein step (D) comprises:
formatting an e-mail message to include a reference to the received financial transaction data; and
sending the formatted e-mail message to the user.

116. The method of claim 115, wherein the formatted e-mail message comprises a URL link pointing to the stored received financial transaction data.

117. The method of claim 116, wherein the URL link includes a pointer to a second server.

118. The method of claim 117, further comprising:
under control of a client system:
receiving the e-mail message; and
clicking on the URL link; and
under control of the second server:
receiving an indication from the client system that the URL link is being accessed;
validating the user;
identifying the stored financial transaction data location from the URL link; and
when the user has been validated, directing the user to the financial transaction data stored on the first server.
